(19) United States
(12) Patent Application Publication
(10) Pub. No.: US 2015/0346921 A1
(43) Pub. Date: Dec. 3, 2015

(54) APPARATUS AND METHOD FOR DISPLAYING RELATIVE LOCATION OF PERSONS, PLACES OR OBJECTS

(71) Applicant: HISEP TECHNOLOGY LTD., Yavne (IL)

(72) Inventors: YARIV ERAD, KIDRON (IL); GAD VERED, BE'ER YA'AKOV (IL)

(21) Appl. No.: 14/654,555

(22) PCT Filed: Nov. 19, 2014
(86) PCT No.: PCT/IL2014/051008

§ 371 Date: Jun. 22, 2015

Related U.S. Application Data
(60) Provisional application No. 61/906,550, filed on Nov. 20, 2013.

(51) Int. Cl. G06F 3/0482; H04L 29/08

(52) U.S. Cl. CPC G06F 3/0482; H04L 67/18

(57) ABSTRACT

The subject matter discloses an electronic device having a circular display device, comprising a relative location unit for determining a relative location of one or more Targets relative to the electronic device, a circular display device for displaying the relative location of the one or more Targets relative to a Looker displayed in a center of the circular display device and a processor for determining information displayed on the circular display device.

### FIELD OF THE INVENTION

The invention generally relates to displaying items, more specifically to displaying persons, places or objects according to their relative locations.

### BACKGROUND OF THE INVENTION

There are many technologies and devices used for determining the absolute location of objects and persons, such as GPS and triangulation. The information extracted from these devices is processed and later displayed on a display device, for example on a smartphone, tablet or any other electronic device. In many cases, there is a need to display the location of many objects, persons, or places simultaneously, for example many products in a retail store.

The translation of the absolute location to a map is problematic as there are many items, or when high resolution is required. The close proximity to every data item on the map, the need to scale down the map to correlate between what the user can see with his own eyes to what is being presented on the map, and the need to overlay the data on the location map, require applications providers to significantly reduce the amount of data displayed to the user.

This problem intensifies when accumulating more information and metadata about the items to be displayed, which requires more complex maps, interfaces, menus and layers to be displayed in a very non-intuitive manner Many display devices of mobile electronic devices are rectangular or square, while the natural way a person observes his surroundings is shaped as a center of a circle or a ball, when adding a third dimension. As a result, the maps displayed on a rectangular or square display devices do not provide the user with an experience that simulates real life.

### SUMMARY OF THE INVENTION

It is an object of the subject matter to disclose an electronic device having a circular display device, comprising a relative location unit for determining a relative location of one or more Targets relative to the electronic device; a circular display device for displaying the relative location of the one or more Targets relative to a Looker displayed in a center of the circular display device; and a processor for determining information displayed on the circular display device.

In some cases, the electronic device further comprises a receiving unit for receiving an absolute location of the electronic device and information concerning absolute location of the one or more Targets. In some cases, the electronic device further comprises a user interface, wherein the circular display device displays a new Looker in the center of the circular display device according to a gesture performed on the user interface with regard to a selected Target.

In some cases, the electronic device further comprises a ring-shaped display device surrounding at least a portion of the circular display device and being electronically coupled to the circular display device. In some cases, the ring-shaped display device shows information about the one or more Targets displayed in the circular display device. In some cases, the ring-shaped display device is rotatable around the circumference of the circular display device. In some cases, the ring-shaped display device is made of a curved material. In some cases, an action performed on the circular display device interacts with information displayed on the ring-shaped display device. In some cases, an action performed on the ring-shaped display device interacts with information displayed on the circular display device. In some cases, the ring-shaped display device is rotatable around an axis of the circular display device. In some cases, the ring-shaped display device is configured to display the location of the one or more Targets relative to the location of the electronic device.

In some cases, the ring-shaped display device displays general information of a Target selected from the one or more Targets responsive to a predefined gesture performed by a user of the electronic device on the selected Target. In some cases, the electronic device further comprises a second ring display device surrounding a portion of the circumference of the circular display device. In some cases, the circular display device also shows the orientation of the electronic device points, such that the user can understand from the circular display device an orientation of at least one Target of the one or more additional Targets.

In some cases, the processor generates a fish-eye spherical display of the Target displayed on the center of the circular display device and the one or more additional Targets. In some cases, a display orientation of the circular display device changes according to a relative location of a user of the electronic device. In some cases, the processor is configured to match a person from a group of potential Lookers associated with the electronic device and changing the display orientation according to the matched person. In some cases, the circular display device is made of elastic materials and the electronic device further comprises fastening elements for affixing the circular display device in a predefined position.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a circular display device displaying several Targets according to their relative locations, in accordance with a preferred embodiment of the invention;

FIGS. 2A, 2B and 2C show a main circular display device with a ring-shaped or semi-ring shaped display device attached thereto, according to exemplary embodiments of the subject matter;

FIG. 3 shows a main circular display device with a ring-shaped display device displaying a menu for the user, according to exemplary embodiments of the subject matter;

FIG. 4 shows a main circular display device with a ring-shaped display device displaying additional Targets according to their relative locations, according to exemplary embodiments of the subject matter;

FIG. 5A shows a main circular display device with a fish-eye display interface, according to exemplary embodiments of the subject matter;

FIG. 5B shows a main circular display device with unified display interface, according to exemplary embodiments of the subject matter;

FIG. 5C shows a main circular display device with a fish-eye spherical display interface, according to exemplary embodiments of the subject matter;

FIG. 5D shows a main circular display device with a fish-eye spherical display interface, according to exemplary embodiments of the subject matter;

FIG. 6 shows a main circular display device displaying general information about a Target displayed on the relative location display configuration, according to exemplary embodiments of the subject matter;

FIG. 7 shows a main circular display device while changing display configuration according to a command from a user, according to exemplary embodiments of the subject matter;

FIG. 8 shows a schematic diagram of a mobile electronic device comprising various electronic components, according to exemplary embodiments of the subject matter; and,

FIGS. 9A-9C show optional embodiments for a curved display device, according to exemplary embodiments of the subject matter.

### DETAILED DESCRIPTION OF THE INVENTION

The present invention discloses a mobile electronic device having a circular display device. The circular display device is configured to display a Looker in the center of the display device and additional Targets in the various directions spanned from the Looker in the center of the display device, according to their relative location. The mobile electronic device also comprises a processor for determining the information displayed on the display device according to a predefined set of rules, as will be detailed below. In some exemplary cases, the circularly displayed information may be virtual and projected from an electronic device. The projected information shows the Looker in the center of the circle and the Targets outside the circle. A user of the present invention may use a standard and known electronic device, such as Google Glasses, in augmented reality technologies, in order to project the information, without the need to manufacture a physical circular display device.

The Looker of the disclosed subject matter may be defined as the user of the mobile electronic device on which the relative locations of additional Targets are displayed. Said Looker may be represented by an icon. The use of such icon and its constant position in the center of the display (regardless to the absolute location of the user), is devised to reflect that the Relative Location data is presented in relation to the user. The Targets of the disclosed subject matter may be defined as additional persons or objects displayed on the display device around the Looker that is displayed in the center of the display device. The Targets may be persons, objects, products, vehicles and the like. The Targets may be displayed in their relative position vs. the Looker and also in their Relative Location vs. other Targets. The benefit of displaying the Targets in such manner is that it offers the best correlation between the real-world view around the user of the mobile electronic device and how the real world is displayed on the display device for the user.

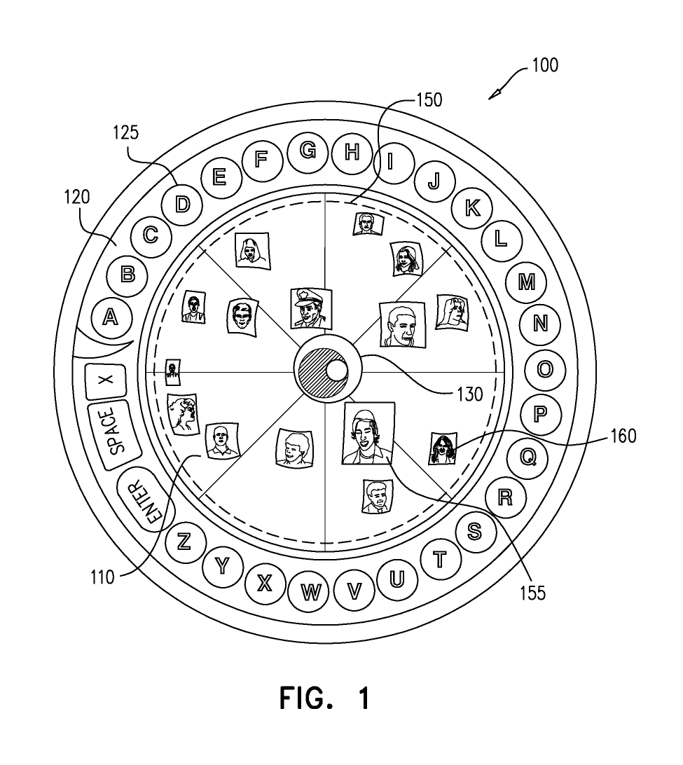

FIG. 1 shows a circular display device displaying several Targets according to their relative locations, in accordance with a preferred embodiment of the invention. The circular display device 100 comprises a main display device 110. The center 130 of the main display device 110 displays a predefined Looker. The Looker may be the person holding the mobile electronic device that comprises the circular display device 100. The Looker in the center 130 may change according to a command from the user of the mobile electronic device, for example by pressing a specific area on the circular display device 100, or by a command from a remote location.

The main display device shows additional Targets according to their relative location from the Looker in the center 130. The relative location is acquired via a relative location unit inside the mobile electronic device, or extracted from absolute location information. The Targets may be persons, products in a store, vehicles, animals, moving and non-moving objects, places and the like. As such, Targets 155 and 160 are shown on the main display device 110 in accordance to their relative location from the Looker displayed in the center 130. The display properties of the Targets 155, 160 may vary over time, or responsive to predefined rules or events. For example, the size of image representing a Target on the circular display device 100 may be determined according to the distance between the Target and the center 130. As such, the image representing Target 160 is larger than the image representing Target 155.

The relative location may be defined as a combination of direction, distance and difference in altitude of the Looker in the center 130 and the Targets displayed on the main display device 110. The main display device 110 may also show metadata of the Targets displayed out of the center 130 of the main display device 110, for example Target's name, size, actual distance from the Looker in the center 130, and the like. In some cases, the main display device 110 may display circles or lines such as line 150 that represent distances from the Looker in the center 130. For example, the main display device 110 may display 5 circles in the distances of 50, 100, 200, 500 and 1000 meters from the Looker displayed in the center 130.

In some cases, the circular display device 100 comprises a ring-shaped display device 120 in addition to the main display device 110. The ring-shaped display device 120 may be electronically coupled to the main display device 110, may be removable from the main display device 110, or may be part of the same display device, virtually separated from the main display device 110 in order to enable the user of the circular display device 100 to enhance the information displayed on the circular display device 100. The ring-shaped display device 120 may rotate around the circumference of the main display device 110, or around an axis of the main display device 110. The ring-shaped display device 120 may display additional information 125 on the Targets, such as name, Target type (person or product) and the like. The ring-shaped display device 120 may display information according to the information displayed on the main display device 110. For example, when the main display device 110 is requested by the user to show more information about a Target shown on the circular display device 100, the ring-shaped display device 120 will show the additional Targets. In many cases, at least one of the main display device 110 and the ring-shaped display device 120 have touch screen capabilities, enabling a user of the circular display device 100 to input information or commands to the circular display device 100.

In some exemplary cases, the absolute location of the additional Targets is obtained from electronic devices associated with each of the Targets. In some other cases, the absolute location of the additional Targets is obtained from a central unit, such as a surveillance server. In those cases, the processor of the mobile electronic device extracts the relative location of the Targets from the absolute locations. In other cases, the relative locations of the Targets are also produced by another computerized entity and the circular display device 100 only displays the information as received. In other cases, the mobile electronic device of the circular display device 100 comprises a relative location unit which determines the relative location of the Targets, for example using cameras, strength of a signal produced at the Targets, RF signals received at the Looker's electronic device and the like.

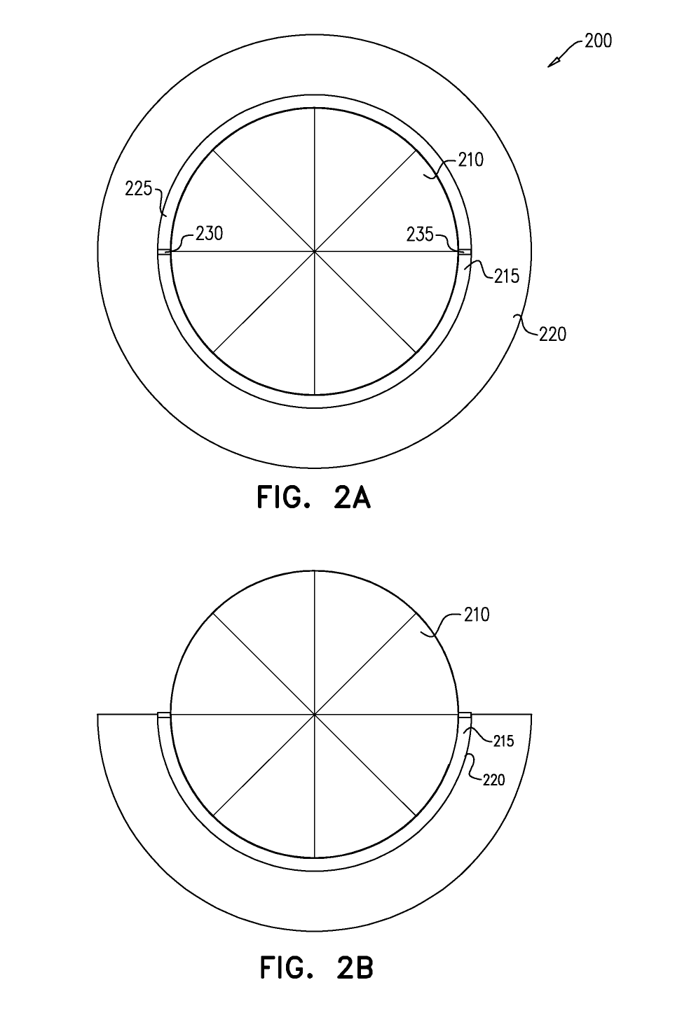

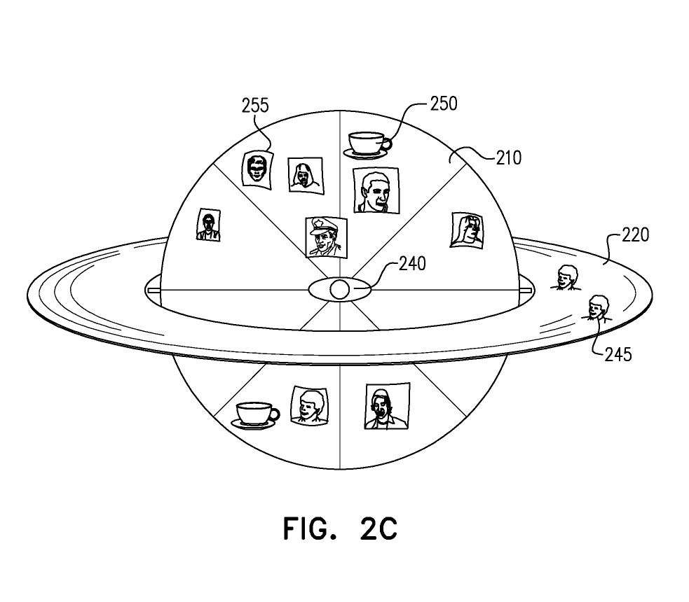

FIGS. 2A, 2B and 2C show a main circular display device with a ring-shaped or semi-ring shaped display device attached thereto, according to exemplary embodiments of the subject matter. The main circular display device 210 is located in the center of the display 200 of the electronic mobile device, and shows the Looker in the center of the display device 200. The main circular display device 210 may be coupled to the ring-shaped display device 220, 225 via an electronic unit 215 that enables data transfer or electronic charge to be passed between the main circular display device 210 and the ring-shaped display device 220, 225. In some exemplary cases, the ring-shaped display device is a two-piece unit made by two half-rings 220 and 225. In some exemplary cases, the ring-shaped display device 220, 225 is attached to the main circular display device 210 via hinges 230, 235 for allowing the ring-shaped display device 220, 225 to rotate around an axis of the main circular display device 210 as shown in FIG. 2C.

FIG. 2B shows the main circular display device 210 with a portion 220 of the ring-shaped display device. The portion 220 may also be electronically coupled to the main circular display device 210 via the electronic unit 215. The portion 220 may be rotatable around the circumference of the main circular display device 210. The rotation may be conducted by the user of the display device 200 or automatically, responsive to an event, such as change of direction of the display device or change of display configuration of information displayed on the main circular display device 210. When rotated around the circumference of the main circular display device 210, the portion 220 may be affixed by elements such as gripping arms, bolts, magnets, protrusion elements and the like.

FIG. 2C shows a main circular display device and a ring-shaped display device rotated over an axis of the main circular display device, according to exemplary embodiments of the disclosed subject matter. The main circular display device 210 is connected to the ring-shaped display device 220 via connectors such as the hinges disclosed above. The center 240 of the main circular display device 210 shows a Looker, for example a user of the mobile electronic device that contains the main circular display device 210. The main circular display device 210 also displays Targets 250, 255 located outside the center 240. The Targets 250, 255 may be represented by images, for example an image of a human's face, an object such as a cup of coffee 250, images of locations such as buildings, images extracted from a web page such as Google Earth and the like. The Targets 250, 255 are displayed according to their relative locations from the Looker displayed in the center 240 of the main circular display device 210. The ring-shaped display device 220 may also show the additional Targets displayed on the main circular display device 210. The ring-shaped display device 220 may display additional Targets, such as Target 245, according to predefined display configurations. For example, the ring-shaped display device 220 only shows Targets of the same altitude as the Looker displayed in the center 240, while the main circular display device 210 shows only Targets in other altitudes. In some other cases, the ring-shaped display device 220 only displays Targets distanced from the Looker more than a predefined threshold, such as 300 meters.

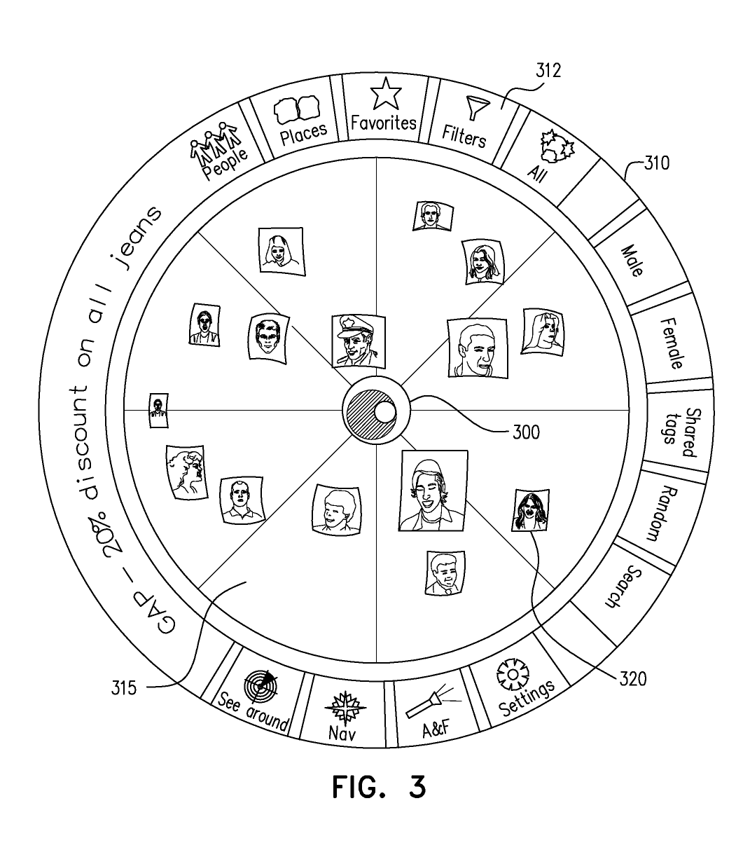

FIG. 3 shows a main circular display device with a ring-shaped display device displaying a menu for the user, according to exemplary embodiments of the subject matter. The main circular display device 315 comprises a center displayed as an eye 300. The eye 300 represents the direction at which the main circular display device 315 points. For example, the eye 300 points at Target 320 that is also displayed on the main circular display device 315. The main circular display device 315 is surrounded by a ring-shaped display device 310. The ring-shaped display device 310 may be an integral part of the main circular display device 315, separated only by the information displayed on the two display devices 315 and 310. In some exemplary cases, a display configuration of the two display devices 315 and 310 may vary or change according to a command from the user of the main circular display device, or responsive to predefined events. For example, both display devices 315 and 310 may display only the Looker in the center, such as the eye 300 and Targets such as the Target 320. In some other display configurations, the ring-shaped display device 310 displays a menu for the user. The menu may be operated by the user via a plurality of icons such as icon 312. Pressing on some icons may lead to sub-menus.

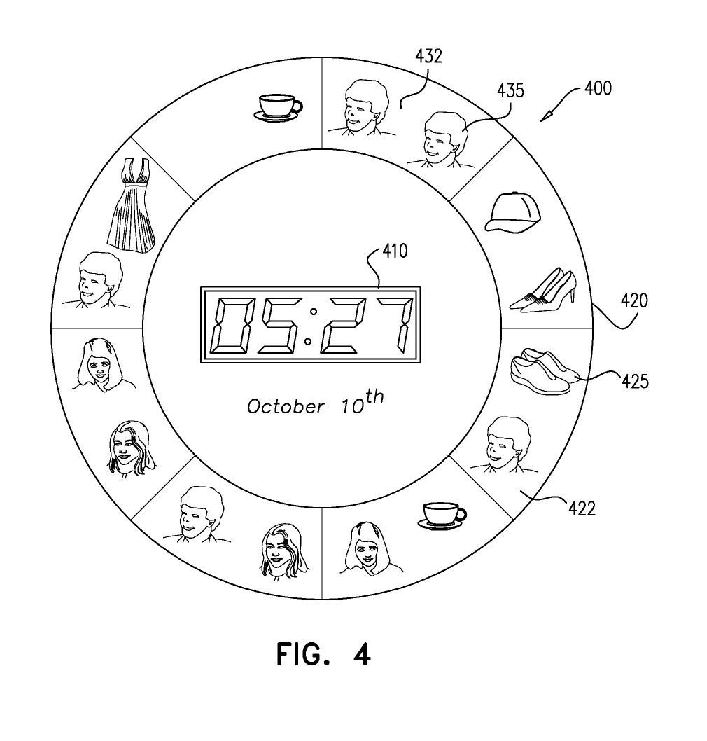

FIG. 4 shows a main circular display device with a ring-shaped display device displaying additional Targets according to their relative locations, according to exemplary embodiments of the subject matter. The circular display device 400 comprises a main circular display device 410 used for general information display configuration. In such a display configuration, the information displayed on the main circular display device 410 is not associated with the relative location of additional Targets and a Looker in the center as disclosed above. The additional Targets are displayed on the ring-shaped display device 420. The ring-shaped display device 420 may be divided into segments 422 and 432 according to predefined rules, for example when there is a reason to suspect that the presence of Targets in some directions may be important to the user of the circular display device. In some exemplary cases, when there are Targets in the specific segments, such as Target 435 in segment 432 and Target 425 in segment 422, the display properties of those Targets may be different, for example in styling or size of the image representing the Targets.

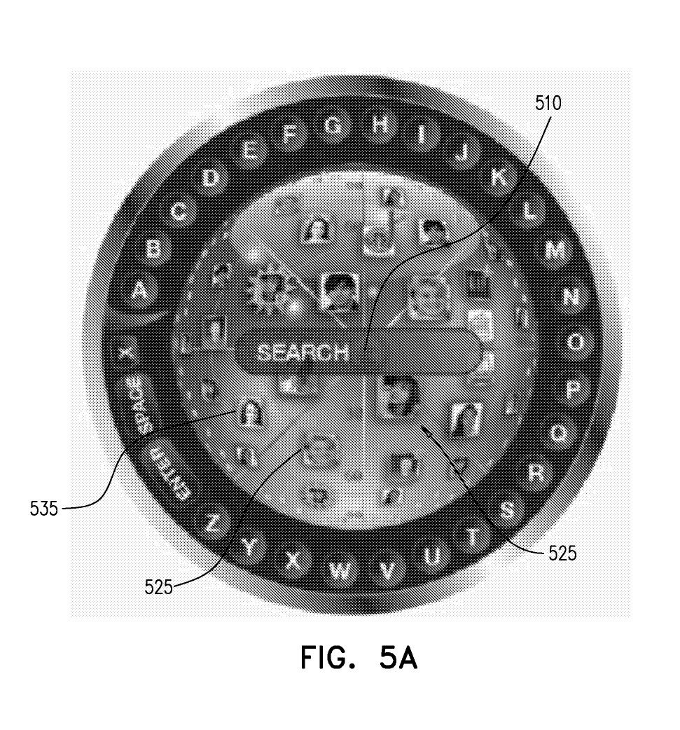

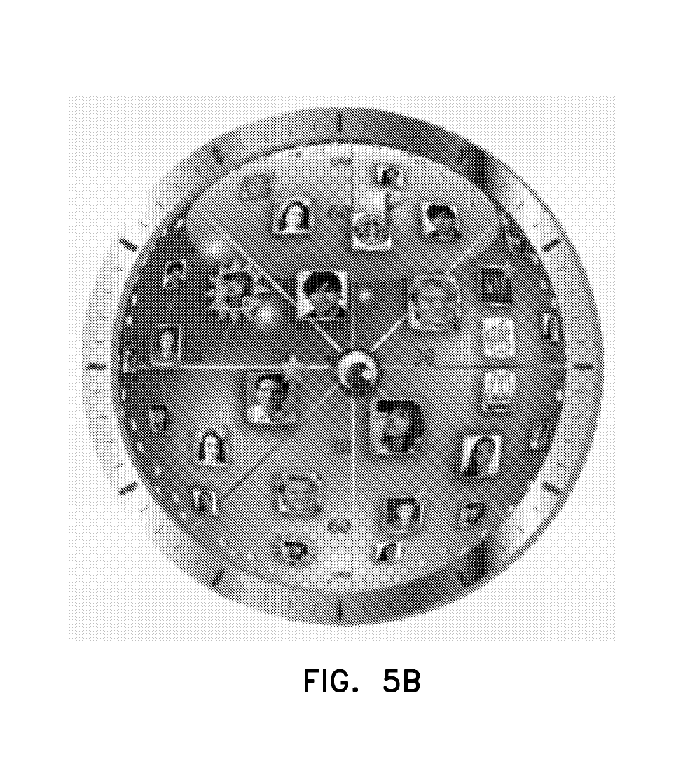

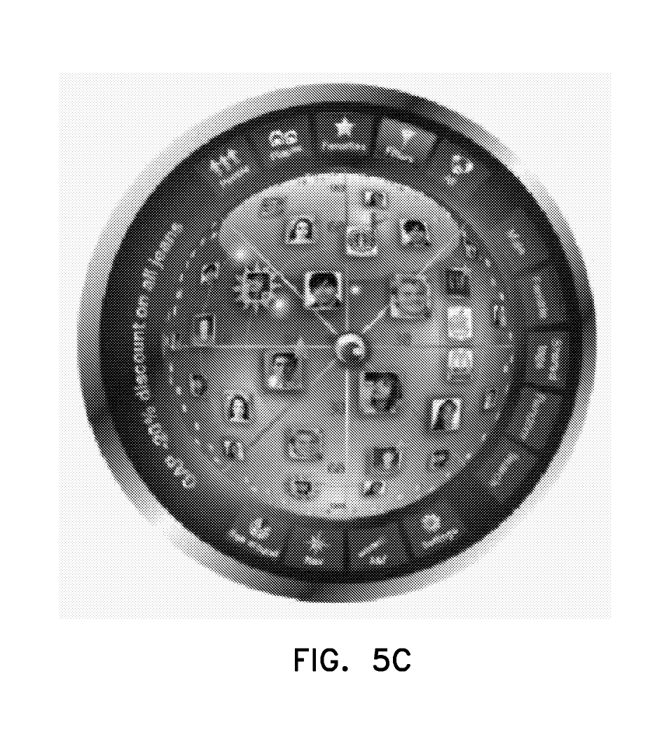

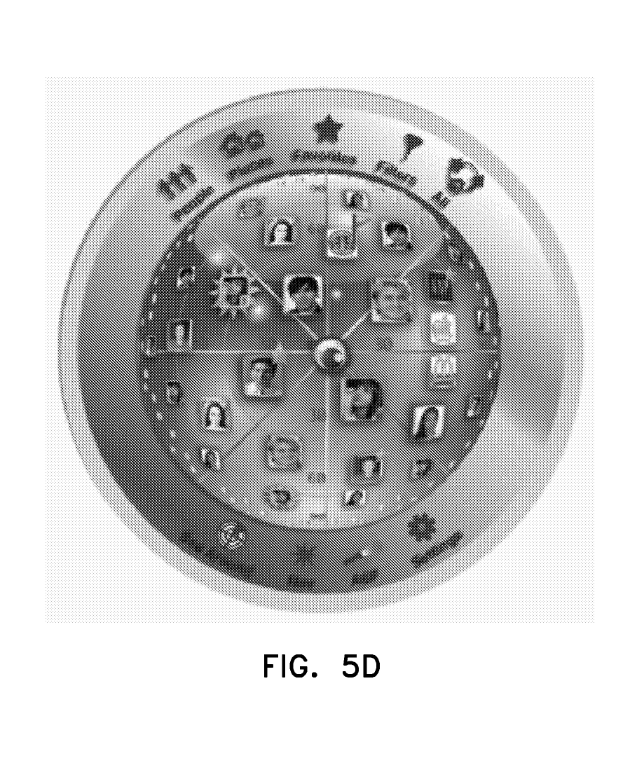

FIG. 5A shows a main circular display device with a fish-eye display interface, according to exemplary embodiments of the subject matter. The fish eye is located at the center 510 of the main circular display device. The fish-eye shows the direction of the main circular display device 525 or the orientation at which the user points in case the information is projected from a wearable device such as Google Glasses. The additional Targets such as Target 530 and 520 are also displayed on the main circular display device 525.

FIG. 5B shows a main circular display device with unified display interface, according to exemplary embodiments of the subject matter. The unified display interface provides that the entire area that contains the main display device and the ring-shaped display device shows the same information, one or more Targets according to their relative location from the Looker.

FIG. 5C shows a main circular display device with a fish-eye spherical display interface, according to exemplary embodiments of the subject matter. The fish eye spherical display interface provides produces a visual distortion intended to create a wide panoramic or hemispherical image.

FIG. 5D shows a main circular display device with a fish-eye spherical display interface, according to exemplary embodiments of the subject matter. The fish eye spherical display interface of FIG. 5D provides a menu displayed on the ring-shaped display device surrounding the main display device.

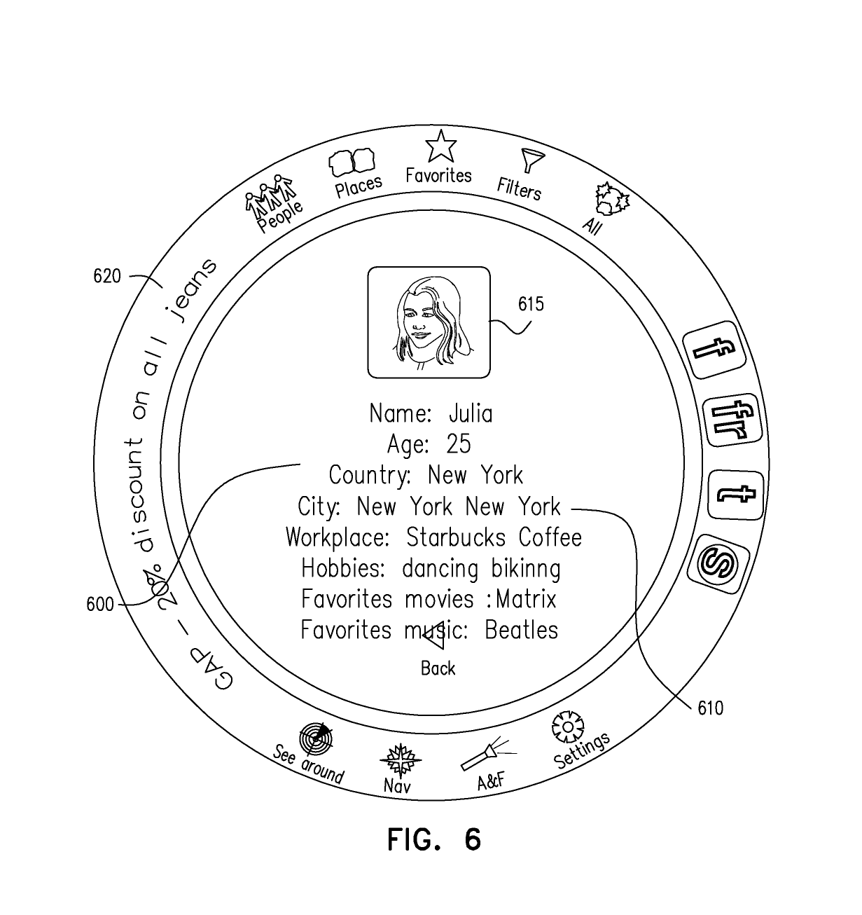

FIG. 6 shows a main circular display device displaying general information about a Target displayed on the relative location display configuration, according to exemplary embodiments of the subject matter. The main circular device 600 may change the display configuration from displaying a Looker in the center and additional Targets around the main circular display device 600 to a display configuration in which general information 610 is displayed in the main circular display device 600 and the additional Targets are displayed in the ring-shaped display device 620. The general information 610 may refer to the Looker previously displayed in the center or to any other Target displayed in the circular display device 600 or the ring-shaped display device 620. The general information display configuration may also include an image 615 of the relevant Target or Looker.

FIG. 7 shows a main circular display device while changing display orientation according to a relative location of the user relative to the electronic device, according to exemplary embodiments of the subject matter. The user's relative location in relation to the electronic device may be determined by acquiring his sound 710 or image may by electronic modules of the mobile electronic device, or by other relative location determination modules of the electronic device, such as RF direction-finding means. According to the acquired said data, a processing unit of the mobile electronic device determines the relative location of the user. Then, the processing unit changes the display orientation 730 in accordance to the user's relative location, from a first display configuration 720 to a second display configuration 740, such that the second display orientation conform to the user's relative location. The user's voice, image or video may be captured by a microphone or another sensor on the display device or via another mobile electronic device connected to the circular display device.

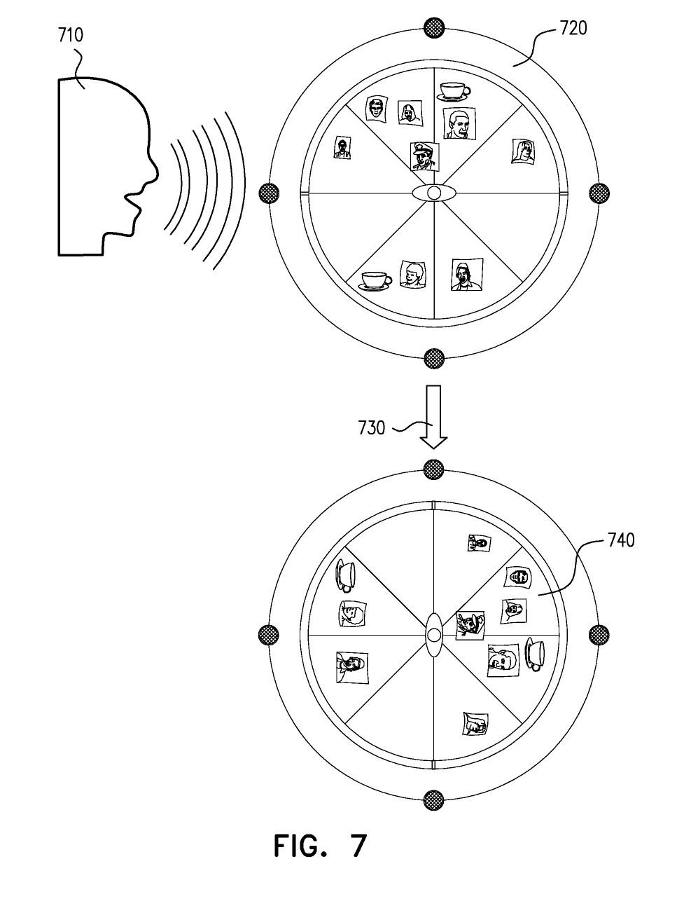

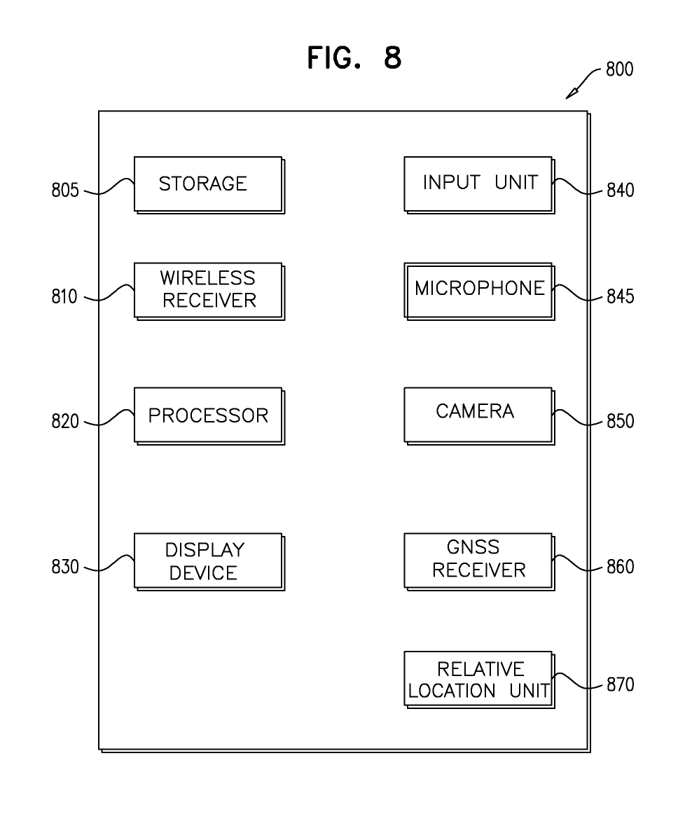

FIG. 8 shows a schematic diagram of a mobile electronic device comprising various electronic components, according to exemplary embodiments of the subject matter.

The electronic components include a storage 805 for storing a predefined set of rules used to operate the circular display device and other electronic components of the mobile electronic device connected to the circular display device. The storage 805 may also store properties associated with various display configurations as disclosed above, such as image size, image type, the images that represent various Targets displayed on the circular display device and the like. The mobile electronic device also comprises a wireless receiver 810 for receiving information from a remote device about the location of other Targets. The information received at the wireless receiver 810 may be the relative location of the other Targets as calculated in the remote device, or an absolute location of the other Targets, and in such a case, a processor 820 of the mobile electronic device will determine the relative location of the other Targets.

The mobile electronic device also comprises a display device 830 for displaying content and information. The display device 830 is configured to display a Target according to its relative location versus another Target that is also displayed in the display device 830. The display device 830 is of a circular shape and may be a single-piece circle. The display device 830 may also contain a ring-shaped display device electronically coupled to the circular display device. The ring-shaped display device may be removable from the circular display device, or may be rotated around the circumference of the circular display device, or around an axis of the circular display device. The display device may be virtual, and project the circularly displayed Targets in front of the user's eyes using augmented reality technology.

The mobile electronic device also comprises an input unit 840. The input unit 840 may be a touch layer on at least a portion of the display device 830. The input unit 840 is configured to receive a command or information from the user of the mobile electronic device to which the circular display device is connected. The input unit 840 may comprise a microphone 845 for receiving vocal commands from the user of the mobile electronic device. The input unit 840 may be used to receive a command to change the display configuration of the display device 830, for example displaying the menu on the ring-shaped display device instead of displaying Targets surrounding the main Targets on the ring-shaped display device.

The mobile electronic device may also comprise a camera 850. The camera may be sued to capture images or video of the mobile electronic device surrounding. The camera 850 may be used for identifying the user of the mobile electronic device when inputting a command to the input unit 840. The camera 850 may be used for identifying physical Targets surrounding the mobile electronic device, such as persons, buildings, products and the like, which are later used to improve the data received about the relative location of those Targets relative to the Target displayed in the center of the display device 830.

The mobile electronic device may also comprise a Global Navigation Satellite System GNSS receiver 860 for receiving signals concerning the absolute location of the mobile electronic device. The GNSS receiver may be or contain a GPS receiver. The GNSS receiver may receive signals from satellites or from antennas locate in the vicinity of the mobile electronic device. The mobile electronic device also comprises a relative location unit 870 for determining the relative location of Targets relative to the mobile electronic device. The relative location unit may also determine the relative location of the user of the mobile electronic device, for example according to the user's voice acquired by a microphone contained in the mobile electronic device. The relative location unit 870 may determine the relative location of the Targets according to signal strength, RF capabilities, cameras and the like.

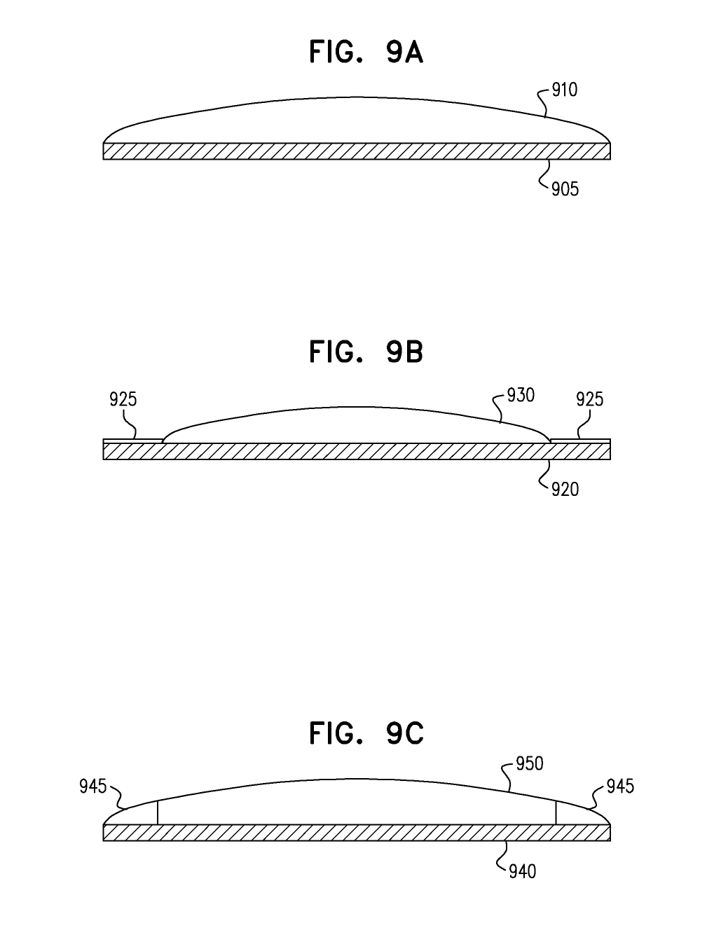

FIGS. 9A-9C show optional embodiments for a curved display device, according to exemplary embodiments of the subject matter. FIG. 9A shows a single display device, without the ring-shaped display device. The curved display device 910 is connected to an electrical connector 905, which may be connected to a body of the mobile electronic device of the disclosed subject matter. FIG. 9B shows a main display device 930 with a curved configuration surrounded by a flat ring-shaped display device 925. Both the curved main display device 930 and the flat ring-shaped display device 925 are connected to an electrical connector 920, as disclosed above. FIG. 9C shows a main display device 950 with a curved configuration surrounded by a curved ring-shaped display device 945. Both the curved main display device 950 and the curved ring-shaped display device 945 are connected to an electrical connector 940, as disclosed above.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An electronic device having a circular display device, comprising:
a relative location unit for determining a relative location of one or more Targets relative to the electronic device;
a circular display device for displaying the relative location of the one or more Targets relative to a Looker displayed in a center of the circular display device;
a processor for determining information displayed on the circular display device.

2. The electronic device of claim 1, further comprises a receiving unit for receiving an absolute location of the electronic device and information concerning absolute location of the one or more Targets.

3. The electronic device of claim 1, further comprises a user interface, wherein the circular display device displays a new Looker in the center of the circular display device according to a gesture performed on the user interface with regard to a selected Target.

4. The electronic device of claim 1, further comprises a ring-shaped display device surrounding at least a portion of the circular display device and being electronically coupled to the circular display device.

5. The electronic device of claim 4, wherein the ring-shaped display device shows information about the one or more Targets displayed in the circular display device.

6. The electronic device of claim 4, wherein the ring-shaped display device is rotatable around the circumference of the circular display device.

7. The electronic device of claim 4, wherein the ring-shaped display device is made of a curved material.

8. The electronic device of claim 4, wherein an action performed on the circular display device interacts with an information displayed on the ring-shaped display device.

9. The electronic device of claim 4, wherein an action performed on the ring-shaped display device interacts with an information displayed on the circular display device.

10. The electronic device of claim 4, wherein the ring-shaped display device is rotatable around an axis of the circular display device.

11. The electronic device of claim 4, wherein the ring-shaped display device is configured to display the location of the one or more Targets relative to the location of the electronic device.

12. The electronic device of claim 4, wherein the ring-shaped display device displays general information of a Target selected from the one or more Targets responsive to a predefined gesture performed by a user of the electronic device on the selected Target.

13. The electronic device of claim 1, further comprises a second ring display device surrounding a portion of the circumference of the circular display device.

14. The electronic device of claim 1, wherein the circular display device also shows the orientation of the electronic device points, such that the user can understand from the circular display device an orientation of at least one Target of the one or more additional Targets.

15. The electronic device of claim 1, wherein the processor generates a fish-eye spherical display of the Target displayed on the center of the circular display device and the one or more additional Targets.

16. The electronic device of claim 1, wherein a display orientation of the circular display device changes according to a relative location of a user of the electronic device.

17. The electronic device of claim 1, wherein the processor is configured to match a person from a group of potential Lookers associated with the electronic device and changing the display orientation according to the matched person.

18. The electronic device of claim 1, wherein the circular display device is made of elastic materials and the electronic device further comprises fastening elements for affixing the circular display device in a predefined position.
